(19) United States
(12) Patent Application Publication
(10) Pub. No.: US 2026/0320153 A1
(43) Pub. Date: Oct. 15, 2026

(54) Systems and Methods for Parallelized Multivariate Time Series Forecasting

(71) Applicant: Google LLC, Mountain View, CA (US)

(72) Inventors: Yuxiang Li, Bothell, WA (US); Haoming Chen, Kirkland, WA (US); Xi Cheng, Kirkland, WA (US)

(21) Appl. No.: 19/176,986

(22) Filed: Apr. 11, 2025

(51) Int. Cl. G06F 17/18

(52) U.S. Cl. CPC G06F 17/18

(57) ABSTRACT

Systems and methods described herein can provide for parallelized multivariate time series forecasting. The systems and methods described herein can provide for obtaining an input dataset including a plurality of univariate time series for a plurality of endogenous variables. Fitted regression models may be identified for each univariate time series by parallelized independent regression. A plurality of residual series may be determined, and one or more exogenous feature values may be extracted based on the fitted regression models. The systems and methods described herein can provide for forecasting a plurality of residual series using fitted forecasting models. Model parameters, forecasted residual series, and exogenous feature values may be stored in a multivariate model table for each endogenous variable. Forecasted time series data can then be generated using this table. The parallelized independent regression on each univariate time series may comprise determining regression matrices respective to a time series identifier. The systems and methods described herein can provide for generating forecasted time series data for each of the endogenous variables.

### FIELD

The present disclosure relates generally to time series forecasting. More particularly, the present disclosure relates to systems and methods for parallelized multivariate time series forecasting.

### BACKGROUND

Time series forecasting involves predicting future data points based on historical time-ordered data. Traditional methods include statistical approaches that analyze patterns in the data, but may have limitations when applied to complex datasets. Deep learning techniques, such as recurrent neural networks, can be used for time series forecasting but may be computationally expensive and computationally constrained if the data sets being processed are large.

### SUMMARY

Aspects and advantages of embodiments of the present disclosure will be set forth in part in the following description, or can be learned from the description, or can be learned through practice of the embodiments.

One example aspect of the present disclosure is directed to a computing system for parallelized multivariate time series forecasting. The computing system includes one or more processors and one or more non-transitory storage media coupled to the one or more processors. The one or more non-transitory storage media store instructions that, when executed by the one or more processors, cause the one or more processors to perform operations. The operations include obtaining an input dataset including a plurality of univariate time series respective to a plurality of endogenous variables. The operations include identifying a plurality of fitted regression models respective to the plurality of univariate time series by parallelized independent regression on each univariate time series of the plurality of univariate time series. The operations further include determining a plurality of residual series respective to the plurality of univariate time series and extracting one or more exogenous feature values from the plurality of univariate time series based on the plurality of fitted regression models. The operations further include forecasting a plurality of forecasted residual series respective to each of the plurality of residual series by a respective fitted residual forecasting model of a plurality of fitted forecasting models. The operations further include storing in a multivariate model table, respective to each endogenous variable, parameters of the respective fitted residual forecasting model, a respective forecasted residual series of the plurality of forecasted residual series, and the one or more exogenous feature values. The operations further include generating, using the multivariate model table, forecasted time series data for each of the endogenous variables.

Another example aspect of the present disclosure is directed to a computer-implemented method. The method includes obtaining, by a computing system including one or more computing devices, an input dataset including a plurality of univariate time series respective to a plurality of endogenous variables. The method includes identifying, by the computing system, a plurality of fitted regression models respective to the plurality of univariate time series by parallelized independent regression on each univariate time series of the plurality of univariate time series. The method further includes determining, by the computing system, a plurality of residual series respective to the plurality of univariate time series and extracting one or more exogenous feature values from the plurality of univariate time series based on the plurality of fitted regression models. The method further includes forecasting, by the computing system, a plurality of forecasted residual series respective to each of the plurality of residual series by a respective fitted residual forecasting model of a plurality of fitted forecasting models. The method further includes storing in a multivariate model table, respective to each endogenous variable, parameters of the respective fitted residual forecasting model, a respective forecasted residual series of the plurality of forecasted residual series, and the one or more exogenous feature values. The method further includes generating, by the computing system and using the multivariate model table, forecasted time series data for each of the endogenous variables.

Another example aspect of the present disclosure is directed to one or more non-transitory storage media. The storage media store instructions that, when executed by one or more processors, cause the one or more processors to perform operations. The operations include obtaining an input dataset including a plurality of univariate time series respective to a plurality of endogenous variables. The operations include identifying a plurality of fitted regression models respective to the plurality of univariate time series by parallelized independent regression on each univariate time series of the plurality of univariate time series. The operations further include determining a plurality of residual series respective to the plurality of univariate time series and extracting one or more exogenous feature values from the plurality of univariate time series based on the plurality of fitted regression models. The operations further include forecasting a plurality of forecasted residual series respective to each of the plurality of residual series by a respective fitted residual forecasting model of a plurality of fitted forecasting models. The operations further include storing in a multivariate model table, respective to each endogenous variable, parameters of the respective fitted residual forecasting model, a respective forecasted residual series of the plurality of forecasted residual series, and the one or more exogenous feature values. The operations further include generating, using the multivariate model table, forecasted time series data for each of the endogenous variables.

In some implementations, identifying the plurality of fitted regression models respective to the plurality of univariate time series comprises extracting a plurality of subtables respective to the plurality of endogenous variables.

In some implementations, extracting the plurality of subtables can include: identifying a first value in a time series identifier column in the input dataset; associating a plurality of rows of the input dataset with a first subtable of the plurality of subtables based on the plurality of rows having the first value in the time series identifier column; identifying a second value in the time series identifier column in the input dataset; and associating a second plurality of rows of the input dataset with a second subtable of the plurality of subtables based on the second plurality of rows having the second value in the time series.

In some implementations, the one or more exogenous feature values comprise an exogenous feature weight and an exogenous feature intercept.

In some implementations, the multivariate model table comprises, for each endogenous variable of the plurality of endogenous variables: a first portion storing the parameters of the respective fitted residual forecasting model; a second portion storing the respective forecasted residual series; and a third portion storing the one or more exogenous feature values. The first portion, the second portion, and the third portion respectively can be a plurality of nonoverlapping rows and a plurality of nonoverlapping columns.

In some implementations, the plurality of nonoverlapping rows and the plurality of nonoverlapping columns comprise null values in overlapping positions.

In some implementations, the plurality of fitted regression models comprise linear regression models and wherein the parallelized independent regression comprises linear regression.

In some implementations, the plurality of fitted forecasting models comprise autoregressive integrated moving average (ARIMA) models.

In some implementations, forecasting the plurality of forecasted residual series respective to each of the plurality of residual series by the respective fitted residual forecasting model of the plurality of fitted forecasting models includes: generating, for each residual series of the plurality of residual series, a plurality of candidate forecasting models; evaluating a performance criterion for each of the plurality of candidate forecasting models; and selecting one of the plurality of candidate forecasting models as the respective fitted residual forecasting model for the residual series based on the performance criterion.

In some implementations, the performance criterion comprises an Akaike information criterion (AIC).

In some implementations, the performance criterion comprises an error rate.

In some implementations, the parallelized independent regression comprises fitting a regularization parameter to the plurality of univariate time series.

In some implementations, the parallelized independent regression comprises, for each univariate time series of the plurality of univariate time series: decomposing data points of the univariate time series into a plurality of coefficients; generating a coefficient matrix based on the plurality of coefficients; determining parameters of the fitted regression model respective to the univariate time series based on a factor comprising a sum of the regularization parameter with the product of a transposed coefficient matrix multiplied by the coefficient matrix.

In some implementations, the parallelized independent regression is parallelized among a plurality of worker systems according to a parallelization schedule.

In some implementations, generating, using the multivariate model table, the forecasted time series data for each of the endogenous variables includes: obtaining a forecasting dataset comprising a second plurality of univariate time series respective to the plurality of endogenous variables; determining a plurality of feature combination series respective to the second plurality of univariate time series; retrieving the plurality of forecasted residual series from the multivariate model table; and aggregating the plurality of forecasted residual series and the plurality of feature combination series to generate the forecasted time series data.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs parallelized multivariate time series forecasting according to example embodiments of the present disclosure.

FIG. 1B depicts a block diagram of an example computing device that performs parallelized multivariate time series forecasting according to example embodiments of the present disclosure.

FIG. 1C depicts a block diagram of an example computing device that performs parallelized multivariate time series forecasting according to example embodiments of the present disclosure.

FIG. 2 depicts a system for parallelized multivariate time series forecasting according to example aspects of the present disclosure.

FIG. 3 depicts an example model table according to example aspects of the present disclosure.

FIG. 4 depicts a system for parallelized multivariate time series forecasting according to example aspects of the present disclosure.

FIG. 5 depicts a flow chart diagram of an example method for parallelized multivariate time series forecasting according to example aspects of the present disclosure.

FIG. 6 depicts a flow chart diagram of an example method for parallelized multivariate time series forecasting according to example aspects of the present disclosure.

Reference numerals that are repeated across plural figures are intended to identify the same features in various implementations.

### DETAILED DESCRIPTION

### Overview

Generally, the present disclosure is directed to multivariate time series forecasting. Conventional approaches for time series forecasting can rapidly become intractable as the number of variables scales. As one motivating example, consider Stock Keeping Unit (SKU) forecasting. SKU forecasting is a valuable problem that is used to inform the supply of, and pricing of, SKUs for various products, goods, and services. As one example, SKU forecasting can be used by retailers, including but not limited to online retailers to forecast the future stock availability for SKUs based on the past sales trends for various SKUs. SKU forecasting can also be used for various other applications including, for example, the forecasting of product delivery schedules. However, conventional approaches for SKU forecasting can rapidly become intractable as the size and dimensionality of the SKUs and the seasonality of the stock availability increases. For example, one approach is to attempt to train a single forecasting model for each SKU, which is a combinatorial optimization problem whose solution can be NP-hard. Large retailers may track thousands if not millions of SKUs, each of which is affected not only by the demand for a particular product, but also by the demand for other products, external factors such as season, weather, consumer trends, economic factors, promotions, and a host of other factors. Existing approaches for large-scale multivariate forecasting are not only computationally intractable, but are organizationally challenging and quickly become taxing for users of forecasting systems. For example, maintaining a separate forecasting model for each of millions of SKUs can equally require millions of user queries for training and evaluation, which can be infeasible. This is but one example paradigm in which existing time series forecasting can present opportunities for improved efficiency.

The present disclosure provides a solution for this problem by providing parallelized multivariate forecasting. In particular, the present disclosure describes a method for forecasting multiple related time series at once, handling the complexity that arises when many variables are involved by breaking down the multivariate forecasting problem into smaller, independent pieces that can be processed concurrently while still accounting for complex interdependencies within the forecasted data. This can involve first removing the influence of external factors on each time series using a parallelized linear regression technique. Then, the “pure” time series data is used to train individual forecasting models in parallel. A unique storage method is used to save the trained models, where each model is stored in a single table along with its forecasts and feature weights, using a diagonal arrangement with null values to ensure efficient filtering and identification. Finally, when forecasting new data, the system combines the forecasts from the individual models with the effects of external variables to generate a complete multivariate forecast. This approach utilizes parallel processing techniques to handle large datasets efficiently, addressing the limitations of traditional methods that struggle with the scale and complexity of real-world time series forecasting problems.

The present disclosure provides a number of technical effects and benefits, including improvements to computing technology. As one example, the present disclosure can utilize parallelized independent regression, such as generation of a plurality of fitted regression models, using a single query call. The use of a single query call can provide for improved computational efficiency and scalability compared to existing approaches that require individual user queries for each univariate time series. For example, the present disclosure can utilize parallelized independent regression among a plurality of worker systems to reduce a number of user calls, queries, and other user interactions associated with forecasting a large, complex dataset, thereby reducing computing resources, network resources, bandwidth, and the like required to train and evaluate fitted regression models, forecast residuals, and forecast multivariate time series data.

As another example, the present disclosure can provide a technical solution for the particular computing-technology related problem of model storage and retrieval, arising from the particular use of computing technology. For example, the present disclosure provides for the generation of extremely sizable numbers of model parameters, forecasted residual series, and exogenous feature values, which can be difficult for a relational database engine (RE), such as Structured Query Language (SQL), to parse, query, generate and execute efficiently. One particular challenge in the use of SQL is the efficient discernment of categorical associations in retrieved data. For example, the use of data matching clauses in SQL, where values are searched for in a relational table, can cause inefficient use of computing resources due to the need to identify multiple occurrences in a row of data, such one for each member of the set being located. As another example, the use of metadata for defining relationships between data can quickly become memory and computationally inefficient at scale. As another example, storing data among multiple tables can result in efficiency issues caused by the need to transfer data (e.g., by selecting, loading, or accessing a particular table) prior to retrieval. The present disclosure provides a novel data structure for the model table described herein. The model table described herein provides a “diagonal” or “one-hot” structure in which a plurality of columns are uniquely assigned to store one of either the parameters of the fitted forecasting model, the forecasted residual series, or the one or more exogenous feature values. Portions of the columns that do not store the assigned type of data (e.g., portions that are in a same row as another data type) are assigned a null value. The null values can be ignored during retrieval operations, thereby reducing the amount of data that must be analyzed for each retrieval operation. For example, when retrieving exogenous feature values from the model table, the need to parse through other data, such as the parameters of the fitted forecasting model or the forecasted residual series, or lengthy metadata, can be avoided as these locations would contain null values. This, in turn, can provide for improved forecasting speed in the time series forecasting use case, despite the increased use of data attributed to null values. The present inventors have recognized that the novel data structure formed by a model table using the diagonal configuration described herein can improve computational efficiency and scalability in the multivariate time series forecasting domain and therefore represents a particular technical solution to problems in computing-technology-related field of multivariate time series forecasting, despite the apparent disadvantage of increased memory requirements. Further, the use of the diagonal configuration also provides an improvement to the functioning of computer technology by providing for the efficient storage and retrieval of computationally expensive large numbers of individual forecasted residual series and their respective fitted forecasting models and exogenous feature values for large numbers of time series. Finally, the present disclosure provides for the use of the model table described herein to provide fewer (e.g., a single) model table(s) per user. This can avoid challenges associated with maintaining a plurality of individual model files per user, such as millions of model files corresponding to variables to be forecasted for a particular user, which can rapidly become intractable.

With reference now to the Figures, example embodiments of the present disclosure will be discussed in further detail.

### Example Devices and Systems

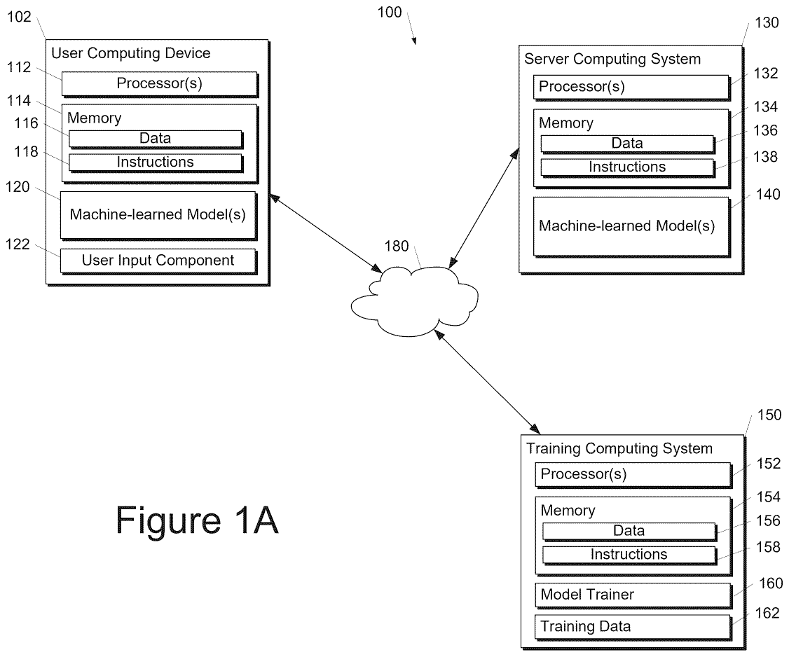

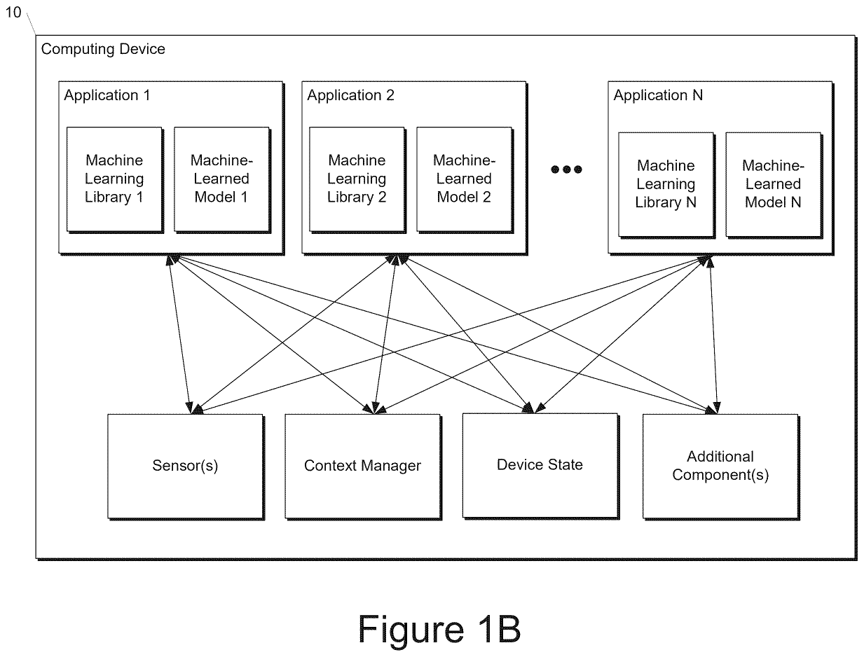

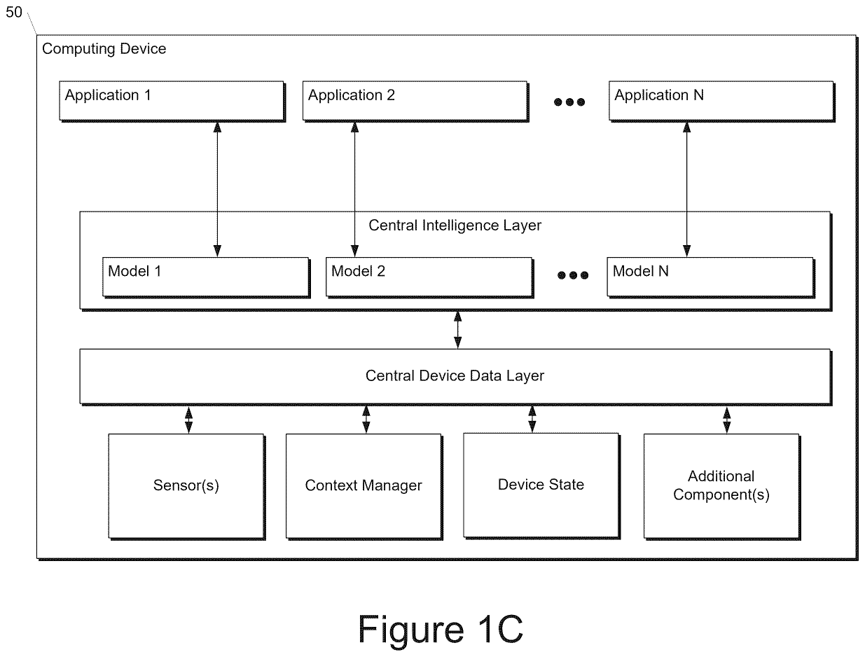

FIG. 1A depicts a block diagram of an example computing system 100 that performs parallelized multivariate time series forecasting according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned model(s) 120. For example, the machine-learned model(s) 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, the one or more machine-learned model(s) 120 can be received from the server computing system 130 over network 180, stored in the user computing device memory 114, and then used or otherwise implemented by the one or more processors 112. In some implementations, the user computing device 102 can implement multiple parallel instances of a single machine-learned model(s) 120 (e.g., to perform parallel time series forecasting across multiple instances)

Additionally or alternatively, one or more machine-learned model(s) 140 can be included in or otherwise stored and implemented by the server computing system 130 that communicates with the user computing device 102 according to a client-server relationship. For example, the machine-learned model(s) 140 can be implemented by the server computing system 140 as a portion of a web service (e.g., a forecasting service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For instance, the training computing system 150 can train some models (e.g., ARIMA models) using regression techniques. Alternatively, in some implementations, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, an input dataset including a plurality of univariate time series. As described herein, the input dataset can be used to learn a forecasted residual series for each endogenous variable that is included in the input dataset. The learned forecasted residual series can then be used to generate forecasted time series data for the endogenous variables from additional time series data. In this manner, the system can be scaled to a massive number of time series variables while capturing the complex interdependencies between the endogenous variables and between the endogenous variables and exogenous factors, which may or may not be explicitly recorded in the time series data.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases. In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output. In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output. In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output. In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

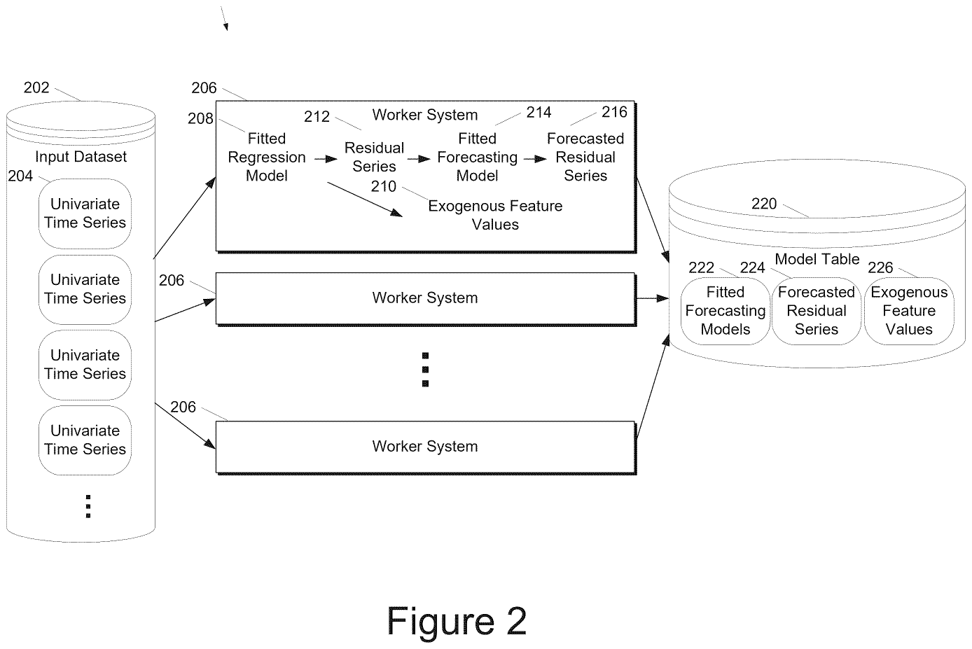

FIG. 2 depicts a system 200 for parallelized multivariate time series forecasting according to example aspects of the present disclosure. The system 200 can obtain an input dataset 202. The input dataset 202 can include a plurality of univariate time series 204 respective to a plurality of endogenous variables. The input dataset 202 can include any suitable type of dataset collected from any suitable source. For example, the input dataset 202 can be weather data, production or logistics data, consumption data, or various other types of data. The input dataset 202 can delineate the univariate time series 204 using any suitable approach. As one example, the input dataset 202 can associate a time series identifier with each univariate time series 204 of the input dataset 202. For example, the input dataset 202 can be a table, and rows of the table can be associated with respective time series identifiers corresponding to the univariate time series 204. In some implementations, multiple columns of the table can be associated with a single univariate time series 204. The time series identifier may be included in the input dataset 202 or, in some implementations, may be selected from a column of the table. For example, if the input dataset 202 describes sales data for various stores, a column such as store number or store identifier may be the time series identifier. Other factors, such as the sales quantities, can represent an endogenous variable corresponding to a univariate time series. In some implementations, multiple columns may be combined to generate the time series identifier. For example, a table of weather data captured from multiple stations in various locations, where some locations have multiple stations, may include a location name column and a station identifier column that is repeated in multiple locations (e.g., a station number that increments by 1 for each station). The time series identifier can be formed using the location name and the station identifier (e.g., New York 1, New York 2, etc.). The input dataset 202 may also be referred to as training data or a training dataset, as the input dataset 202 can be used to generate forecasting models as described further herein.

According to example aspects of the present disclosure, a fitted regression model 208 can be identified for each of the univariate time series 204 by parallelized independent regression. In this manner, the multivariate time series forecasting can be parallelized by dividing the multivariate time series forecasting into a plurality of smaller univariate time series forecasts. In particular, each of the parallelized independent regression operations can be assigned to a particular worker system 206. Each of the worker systems 206 can determine its own forecasting for the univariate time series 204 assigned to it. For example, the data of the input dataset 202 may be partitioned into a plurality of portions corresponding to each univariate time series 204, and each portion of the dataset 202 can be distributed to a corresponding worker system 206. Each worker system 206 can run, in parallel with the other worker systems 206, a regression analysis to fit the fitted regression model 208 to its assigned portion of the dataset 202. The worker systems 206 can each determine a fitted regression 208 using any suitable approach, such as, for example, a linear regression.

In some implementations, a single query (e.g., SQL query) can be used to partition the input dataset 202 and to execute the regression on the dataset portions assigned to the worker systems 206. For instance, the query can itself instruct the system 200 to perform parallel multivariate forecasting using parallelized independent regression techniques. As one example, the query can define a time series identifier column that is preserved consistently throughout execution of the regression and subsequent operations. By grouping the dataset 202 based on the time series identifier, the dataset 202 can be partitioned into subsets corresponding to the number of worker systems 206 and variables to be forecasted. The system can therefore involve a single matrix multiplication for each univariate time series 204 to generate the fitted regression models 208, without affecting other univariate time series 204 and therefore providing accurate predictions.

Because the fitted regression model 208 can be estimated independently, the fitted regression model 208 can accurately estimate the univariate time series 204. Generally, however, forecasting multivariate time series can benefit in accounting for interdependencies and/or other relationships between the plurality of univariate time series 204 and/or the effects of exogenous factors on the time series data. The system 200 (e.g., the worker systems 206) can therefore extract one or more exogenous feature values 210 from the plurality of univariate time series 204 based on the plurality of fitted regression models 208. The one or more exogenous feature values 210 can be features based on the endogenous variables to which the multivariate time series forecasting is applied, but which are not captured in the univariate time series 204 of the input dataset 202. For example, the exogenous feature values 210 can account for the effects of external factors on the plurality of univariate time series 204 of the input dataset 202. As one example, the exogenous feature values 210 in time series data indicative of product sales can represent, for example, weather-related factors, seasonality related factors, promotions related factors, or various other factors that are not explicitly demarcated in the univariate time series 204. For example, while weather and season may have a significant impact on sales, the input dataset 204 may not explicitly model weather data. The exogenous feature values 210 may not necessarily be labeled as a particular type of effect. For example, in some implementations, the exogenous features may be labeled as “feature 1” or “f1” or some similar agnostic labeling that is not tied to a particular effect. In this manner, the exogenous feature values 210 can model unexpected or otherwise unknown, albeit present, effects within the univariate time series 204.

In some implementations, the plurality of fitted regression models 208 can be linear regression models and the parallelized independent regression comprises linear regression. For example, linear regression can be relatively computationally simple while still performing well for time series forecasting tasks. Additionally and/or alternatively, other forms of regression, such as polynomial regression, can be utilized.

Identifying the plurality of fitted regression models 208 respective to the plurality of univariate time series 204 comprises extracting a plurality of subtables respective to the plurality of endogenous variables. Each subtable can correspond to one of the plurality of univariate time series 204 and one endogenous variable. For example, each time series identifier (corresponding to univariate time series 204) can similarly define one endogenous variable. The subtables can therefore capture the data in each univariate time series 204 and be labeled with an appropriate time series identifier, which can simplify future data retrieval and storage operations even when the endogenous variables are otherwise not clearly defined.

In some implementations, extracting the plurality of subtables can include identifying a first value in a time series identifier column 406 in the input dataset 202. Extracting the plurality of subtables can additionally associating a plurality of rows 415 of the input dataset 202 with a first subtable of the plurality of subtables based on the plurality of rows 415 having the first value in the time series identifier column 406. For example, if the first value of the time series identifier column is, for illustration only, a value such as “identifier 1,” each row having the “identifier 1” value in the time series identifier column can be associated with the first subtable. Furthermore, in some implementations, extracting the plurality of subtables comprises identifying a second value in the time series identifier column 406 in the input dataset 202. Extracting the plurality of subtables can additionally include associating a second plurality of rows 420 of the input dataset 202 with a second subtable of the plurality of subtables based on the second plurality of rows 420 having the second value in the time series. For example, if the second value of the time series identifier column is, for illustration only, a value such as “identifier 2,” each row having the “identifier 2” value in the time series identifier column can be associated with the second subtable. In this manner, the input dataset 202 can be partitioned into a first plurality of portions corresponding to the first subtable and the first multivariate time series 204 and a second plurality of portions corresponding to the second subtable and the second multivariate time series 204, where the multivariate time series forecasting is implemented on a worker system 206 respective to the first plurality of portions corresponding to the first subtable and the first multivariate time series 208 and a worker system 206 respective to the second plurality of portions corresponding to the second subtable and the second multivariate time series 204. The respective portions can then be allocated to respective worker systems 206, where each worker system 206 can run a regression on the univariate time series forecast of that portion.

Furthermore, in some implementations, the parallelized independent regression is parallelized among a plurality of worker systems 206 according to a parallelization schedule. The parallelization schedule may be based on any suitable consideration, such as, for example, the present workload of the worker systems 206, the amount of data in the input dataset 202 (e.g., or a subtable), or other suitable factors. In this manner, the system 200 may be capable of optimizing the allocation of data to the worker systems 206, such as based on the respective loads of each of the worker systems 206, the available processing power of each of the worker systems 206, the amount of data in the dataset 202, or other suitable factors.

Furthermore, in some implementations, the parallelized independent regression can include fitting a regularization parameter to the plurality of univariate time series 204. The regularization parameter can be used to mitigate effects of overfitting, improve generalization, or otherwise improve the performance of the fitted regression models 208. The regularization parameter can be, for example, an L1 or L2 regularization parameter. Furthermore, in some implementations, the regularization parameter can be utilized in determining the fitted regression models 208 For example, in some implementations, the parallelized independent regression can include, for each univariate time series 204 of the input dataset 202, decomposing data points of the univariate time series 204 into a plurality of coefficients. The coefficients can represent the relationship between each regressor and the time series. The parallelized independent regression can further include, for each univariate time series 204 of the plurality of univariate time series 204, generating a coefficient matrix based on the plurality of coefficients. For example, the coefficient matrix can be a matrix combining the coefficients for each of the univariate time series 204. The parallelized independent regression can further include, for each univariate time series 204 of the plurality of univariate time series 204, determining parameters of the fitted regression model 208 respective to the univariate time series 204 based on a factor including a sum of the regularization parameter with the product of a transposed coefficient matrix multiplied by the coefficient matrix.

Additionally and/or alternatively, the system 200 (e.g., the worker systems 206) can generate a plurality of residual series 212 respective to the plurality of univariate time series 204 based on the plurality of fitted regression models 208. The residual series 212 can represent the error or deviation between the fitted regression model 208 and the original univariate time series 204. The residual series 212 can represent the portion of the univariate time series 204 that is unexplained by the exogenous features. For example, the residual series 212 may intuitively represent a “pure” time series with respect to an endogenous variable. Forecasting based on the residual series 212 may thus provide an accurate and robust prediction of one variable of the multivariate time series. Furthermore, according to example aspects of the present disclosure, forecasted data based on these residual series can be combinable to perform a computationally-tractable multi-dimensional multivariate time series forecasting process.

In some implementations, the one or more exogenous feature values 210 can include an exogenous feature weight and an exogenous feature intercept. For instance, the exogenous feature values 210 can define a linear equation indicating the magnitude at which an exogenous factor is included in each univariate time series 204 and, thus, effects the forecasted residual series 212. The one or more exogenous feature values 210 can therefore be used to weight contributions of the one or more exogenous features or effects on the univariate time series 204 in the residual series 212, as described further herein.

The system 200 can further provide for forecasting a plurality of forecasted residual series 216 respective to each of the plurality of residual series 212 by a respective fitted residual forecasting model 214 of a plurality of fitted forecasting models 214. For instance, in some implementations, forecasting the plurality of forecasted residual series 216 can include generating fitted residual forecasting models 214 by fitting the models 214 to the residual series 212. As one example, in some implementations, the plurality of fitted forecasting models 214 can be or can include autoregressive integrated moving average (ARIMA) models. An ARIMA model is a mathematical and/or statistical model that accounts for recurrent periodicities in time series data, and which can be used to forecast future values for univariate time series 204. An ARIMA model includes a plurality of autoregressive terms (the A terms), a plurality of differencing or moving averages (the I terms), and a plurality of integrating terms (the D terms) The ARIMA model therefore can account for recurrent periodicities in the input univariate time series 204 and can be used to determine fitted forecasting models 214 that predict future values of the univariate time series 204. The ARIMA model can include parameters P (the order or number of time lags) of the autoregressive model, D (the degree of differencing or the number of times the data has had past values subtracted) and/or Q (the order of the moving-average model). An ARIMA model may also be seasonal. A seasonal ARIMA model may have multiple sets of parameters defining different “seasons” at different periods within the model.

In some implementations, forecasting the plurality of forecasted residual series 216 respective to each of the plurality of residual series 212 by the respective fitted residual forecasting model 214 of the plurality of fitted forecasting models 214 can include generating, for each residual series 212 of the plurality of residual series 212, a plurality of candidate forecasting models. In some implementations, forecasting the plurality of forecasted residual series 216 respective to each of the plurality of residual series 212 by the respective fitted residual forecasting model 214 of the plurality of fitted forecasting models 214 can include evaluating a performance criterion for each of the plurality of candidate forecasting models. The performance criterion can be any suitable performance metric that consistently evaluates performance of the candidate forecasting models on time series forecasting. As one example, the performance criterion can be an Akaike Information Criterion (AIC). In some implementations, forecasting the plurality of forecasted residual series 216 respective to each of the plurality of residual series 212 by the respective fitted residual forecasting model 214 of the plurality of fitted forecasting models 214 can include selecting one of the plurality of candidate forecasting models as the respective fitted residual forecasting model 214 for the residual series 212 based on the performance criterion. For example, the candidate forecasting model having the best performance metric may be selected. Additionally and/or alternatively, in some implementations, the performance criterion can be an error rate. For example, in some implementations, the candidate model may be selected based on some combination of the AIC and error rate metric, such as a best performing model with respect to AIC that has a relatively low overall error rate, such as zero errors.

The operations further include storing, in a multivariate model table 220 respective to each endogenous variable, parameters of the respective fitted residual forecasting model 214, a respective forecasted residual series 216 of the plurality of forecasted residual series 216, and the one or more exogenous feature values 210. For instance, the parameters of each fitted residual forecasting model 214 can be stored in a parameter store 222. Similarly, the forecasted residual series can collectively be stored as forecasted residual data store 224. The exogenous feature values 210 can likewise be stored in an exogenous feature store 226. Each of the stores 222, 224, and/or 226 can correspond to respective portions (e.g., a first portion, a second portion, a third portion, etc.) of the model table 220. The respective portions may be contiguous or non-contiguous. The multivariate model table 220 can be stored in any suitable memory device such as, for example, a memory of the system 200.

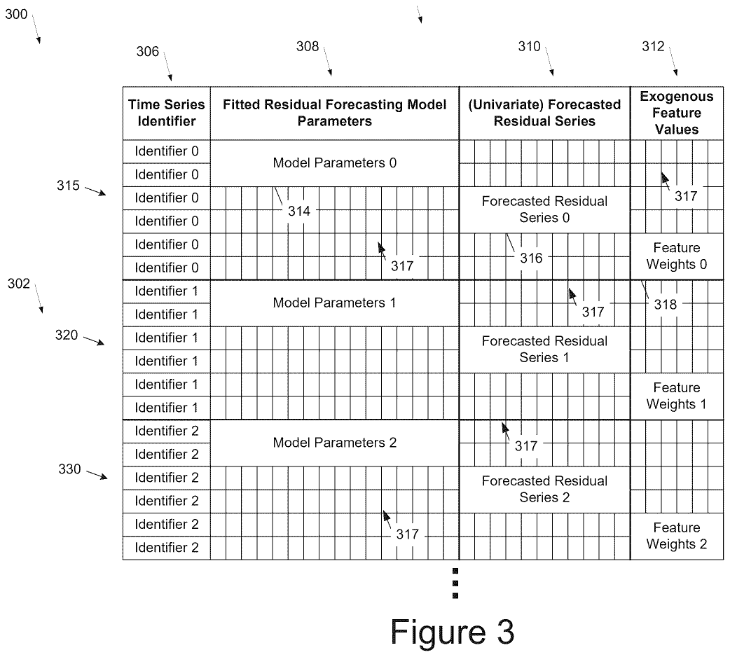

One example multivariate model table 300 generated according to example aspects of the present disclosure is illustrated in FIG. 3. The multivariate model table 300 can be, for example, the multivariate model table 220 of FIG. 2, or may be another multivariate model table according to any of the aspects described herein. The multivariate model table 300 can include a plurality of rows 302 and a plurality of columns 304. Each row 302 can include a time series identifier value within a time series identifier column 306 that demarcates which univariate time series (e.g., and/or which endogenous variable) the row 302 corresponds to. For example, in the multivariate model table 300, rows 315 include a first time series identifier value in the time series identifier column 306 indicating that rows 315 correspond to a first endogenous variable with respect to a first univariate time series, rows 320 include a second time series identifier value in the time series identifier column 306 indicating that rows 320 correspond to a second endogenous variable for a second multivariate time series, and rows 330 include a third time series identifier value in the time series identifier column 306 indicating that rows 330 correspond to a third endogenous variable for a third multivariate time series.

Furthermore, the multivariate model table 300 includes a plurality of column groups that respectively correspond to different portions of the multivariate model table 300. For example, the multivariate model table 300 respectively includes a fitted residual forecasting model parameters column group 308, a forecasted residual series column group 310, and an exogenous feature values column group 312. The fitted residual forecasting model parameters group 308 includes parameters (e.g., P, D, Q tuples) of the fitted residual forecasting model corresponding to the respective time series. The forecasted residual series column group 310 includes values of forecasted residual series corresponding to the respective time series. The exogenous feature values column group 312 includes one or more exogenous feature values based on the respective univariate time series. For example, the exogenous feature values column group 312 can include one or more exogenous feature values of weights and/or intercepts indicative of an effect of the exogenous feature on the time series at given instances in time.

The rows 302 and columns 304 can thus represent respective portions of the multivariate model table 300. For instance, he multivariate model table 300 can include (e.g., for a first endogenous variable of a plurality of endogenous variables) a first portion 314 storing the parameters of the respective fitted residual forecasting model, a second portion 316 storing the respective forecasted residual series, and a third portion 318 storing the one or more exogenous feature values. The first portion 314, the second portion 316, and the third portion 318 respectively can include a plurality of nonoverlapping rows 302 and a plurality of nonoverlapping columns 304. The multivariate model table 300 thus illustrates an example of “diagonal” or “one-hot” data organization of the data of the multivariate model table 300. For example, each portion (e.g., each group 308, 310, 312, etc.) of the multivariate model table 300 can be associated with a respective group of rows 302 and columns 304 that do not include values for other portions. For example, in some implementations, the plurality of nonoverlapping rows 302 and the plurality of nonoverlapping columns 304 can include null values 317 in overlapping positions. For instance, consider the columns of the forecasted residual series column group 310. The second portion 316 is located within the columns of the forecasted residual series column group 310, and is not located within the columns of the fitted regression model parameters column group 308 and the exogenous feature values column group 312. Similarly, the rows 302 of the second portion 316 include values within the forecasted residual series column group 310, but do not include values in the fitted regression model parameters column group 308 and the exogenous feature values column group 312. Other second portions associated with other endogenous variables are similarly located uniquely within the forecasted residual series column group 310. Similarly, the first portion 314 and the third portion 318 associated with other time series can be located within the fitted residual forecasting model parameters column group 308 and the exogenous feature values column group 312, respectively, but not within the forecasted residual series column group 310. Although the example model table 300 depicted in FIG. 3 is larger than other approaches (e.g., not including the null values 317), the present inventors have recognized that model tables 300 according to the arrangement described with respect to FIG. 3 provide unexpectedly improved efficiencies in memory retrieval operations and data storage operations of multivariate time series forecasting data as described herein.

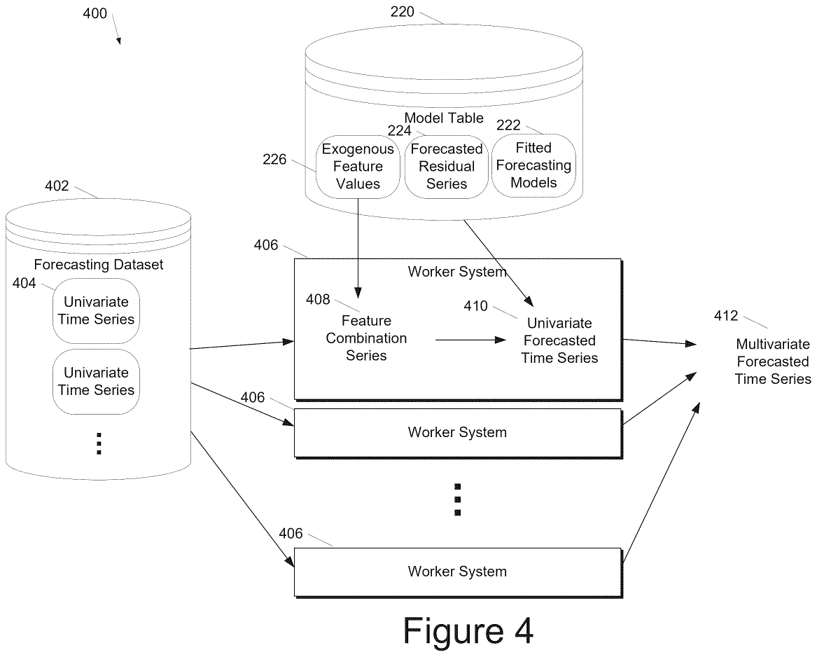

Turning now to FIG. 4, example data forecasting will be discussed in further detail. FIG. 4 depicts a system 400 for parallelized multivariate time series forecasting according to example aspects of the present disclosure. The system 400 can provide for generating, using the multivariate model table 220, forecasted time series data 410 for each of the endogenous variables. In some implementations, generating, using the multivariate model table 220, the forecasted time series data 410 for each of the endogenous variables comprises obtaining a forecasting dataset 402 including a second plurality of univariate time series 404 respective to the plurality of endogenous variables. For example, if the input dataset 202 of FIG. 2 is training data, the forecasting dataset 402 can be a prediction-time dataset. Generating, using the multivariate model table 220, the forecasted time series data 410 for each of the endogenous variables can further include determining a plurality of feature combination series 408 respective to the second plurality of univariate time series 404. In some implementations, generating the feature combination series 408 can be parallelized among a plurality of worker systems 406. The worker systems 406 can be, for example, the worker systems 206 of FIG. 2 or another suitable worker system. Generating, using the multivariate model table 220, the forecasted time series data for each of the endogenous variables can further include retrieving the plurality of forecasted residual series 216 from the multivariate model table 220. Generating, using the multivariate model table 220, the forecasted time series data for each of the endogenous variables comprises aggregating the plurality of forecasted residual series 216 and the plurality of feature combination series 408 to generate the forecasted time series data 410. For instance, the residual series 216 and the feature combination series 408 can be combined with respect to time series identifier and with timestamp or other index. The forecasted time series data 410 can be combined (e.g., in a final output) into multivariate forecasted time series data 412 that includes forecasted values for a plurality of time series.

### Example Methods

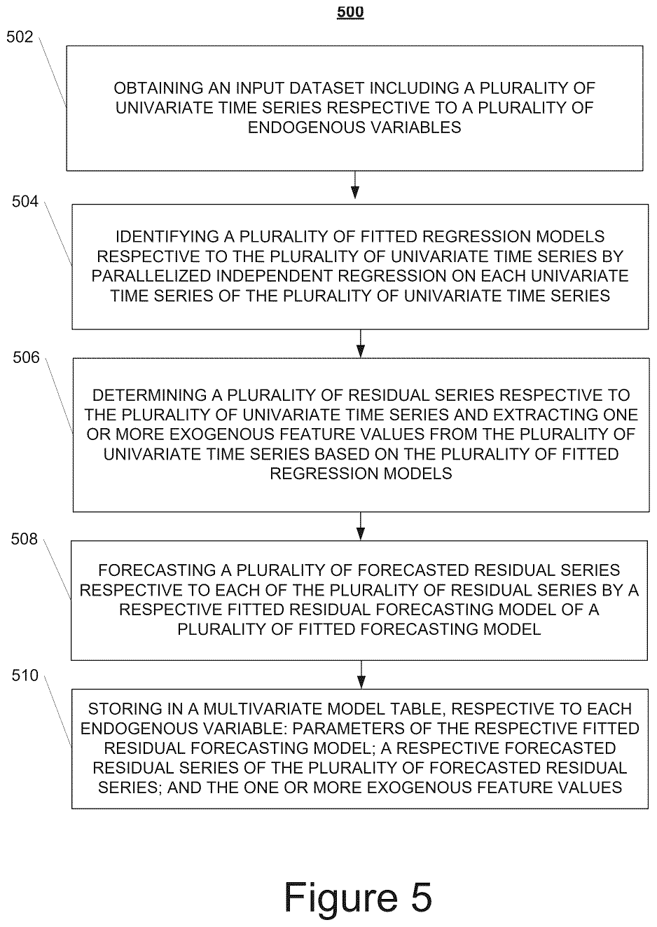

FIG. 5 depicts a flow chart diagram of an example method to perform parallelized multivariate time series forecasting according to example embodiments of the present disclosure. Although FIG. 5 depicts steps performed in a particular order for purposes of illustration and discussion, the methods of the present disclosure are not limited to the particularly illustrated order or arrangement. The various steps of the method 500 can be omitted, rearranged, combined, and/or adapted in various ways without deviating from the scope of the present disclosure.

At 502, the method 500 can include obtaining an input dataset including a plurality of univariate time series respective to a plurality of endogenous variables. The input dataset can be, for example, the input dataset 202 of FIG. 2 or other dataset. For example, the input dataset can be weather data, production or logistics data, consumption data, or various other types of data. The input dataset can delineate the univariate time series using any suitable approach. As one example, the input dataset can associate a time series identifier with each univariate time series. For example, the input dataset can be a table, and rows of the table can be associated with respective time series identifiers corresponding to the univariate time series. In some implementations, multiple columns of the table can be associated with a single univariate time series. The time series identifier may be included in the input dataset or, in some implementations, may be selected from a column of the table. For example, if the input dataset describes sales data for various stores, a column such as store number or store identifier may be the time series identifier. Other factors, such as the sales quantities, can represent an endogenous variable corresponding to a univariate time series. In some implementations, multiple columns may be combined to generate the time series identifier. For example, a table of weather data captured from multiple stations in various locations, where some locations have multiple stations, may include a location name column and a station identifier column that is repeated in multiple locations (e.g., a station number that increments by 1 for each station). The time series identifier can be formed using the location name and the station identifier (e.g., New York 1, New York 2, etc.). The input dataset may also be referred to as training data or a training dataset, as the input dataset can be used to generate forecasting models as described further herein.

At 504, the method 500 can include identifying a plurality of fitted regression models respective to the plurality of univariate time series by parallelized independent regression on each univariate time series of the plurality of univariate time series. For example, the data of the input dataset can be partitioned into a plurality of portions corresponding to each univariate time series, and each portion of the dataset can be distributed to a corresponding worker system. Each worker system can run, in parallel with the other worker systems, a regression analysis to fit the fitted regression model to its assigned portion of the dataset. The trained worker systems can each determine a fitted regression model using any suitable approach, such as, for example, a linear regression. As one example, the fitted regression models, the one or more exogenous feature values, and the forecasted residual series can be generated according to example methods and systems described further below with respect to FIGS. 2-4.

At 506, the method 500 can include determining a plurality of residual series respective to the plurality of univariate time series and extracting one or more exogenous feature values from the plurality of univariate time series based on the plurality of fitted regression models. The residual series can represent the error or deviation between the fitted regression model and the original univariate time series. For example, the residual series may intuitively represent a “pure” time series with respect to an endogenous variable.

For example, in some implementations, the system (e.g., the worker systems) can generate a plurality of residual series respective to the plurality of univariate time series based on the plurality of fitted regression models. The residual series can represent the error or deviation between the fitted regression model and the original univariate time series. The residual series can represent the portion of the univariate time series that is unexplained by the exogenous features. For example, the residual series may intuitively represent a “pure” time series with respect to an endogenous variable. Forecasting based on the residual series may thus provide an accurate and robust prediction of one variable of the multivariate time series. Furthermore, according to example aspects of the present disclosure, forecasted data based on these residual series can be combinable to perform a computationally-tractable multi-dimensional multivariate time series forecasting process.

In some implementations, the one or more exogenous feature values can include an exogenous feature weight and an exogenous feature intercept. For instance, the exogenous feature values can define a linear equation indicating the magnitude at which an exogenous factor is included in each univariate time series and, thus, effects the forecasted residual series. The one or more exogenous feature values can therefore be used to weight contributions of the one or more exogenous features or effects on the univariate time series in the residual series, as described further herein.

At 508, the method 500 can include forecasting a plurality of forecasted residual series respective to each of the plurality of residual series by a fitted residual forecasting model of a plurality of fitted forecasting models. For instance, in some implementations, forecasting the plurality of forecasted residual series can include generating fitted residual forecasting models by fitting the models to the residual series. As one example, in some implementations, the plurality of fitted forecasting models can be or can include autoregressive integrated moving average (ARIMA) models. An ARIMA model is a mathematical and/or statistical model that accounts for recurrent periodicities in time series data and can be used to forecast future values for univariate time series. An ARIMA model includes a plurality of autoregressive terms (the A terms), a plurality of differencing or moving averages (the I terms), and a plurality of integrating terms (the D terms) The ARIMA model therefore can account for recurrent periodicities in the input univariate time series and can be used to determine fitted forecasting models that predict future values of the univariate time series. The ARIMA model can include parameters P (the order or number of time lags) of the autoregressive model, D (the degree of differencing or the number of times the data has had past values subtracted) and/or Q (the order of the moving-average model). An ARIMA model may also be seasonal. A seasonal ARIMA model may have multiple sets of parameters defining different “seasons” at different periods within the model.

In some implementations, forecasting the plurality of forecasted residual series respective to each of the plurality of residual series by the respective fitted residual forecasting model of the plurality of fitted forecasting models can include generating, for each residual series of the plurality of residual series, a plurality of candidate forecasting models. In some implementations, forecasting the plurality of forecasted residual series respective to each of the plurality of residual series by the respective fitted residual forecasting model of the plurality of fitted forecasting models can include evaluating a performance criterion for each of the plurality of candidate forecasting models. The performance criterion can be any suitable performance metric that consistently evaluates the performance of the candidate forecasting models on time series forecasting. As one example, the performance criterion can be an Akaike Information Criterion (AIC). In some implementations, forecasting the plurality of forecasted residual series respective to each of the plurality of residual series by the respective fitted residual forecasting model of the plurality of fitted forecasting models can include selecting one of the plurality of candidate forecasting models as the respective fitted residual forecasting model for the residual series based on the performance criterion. For example, the candidate forecasting model having the best performance metric may be selected. Additionally and/or alternatively, in some implementations, the performance criterion can be an error rate. For example, in some implementations, the candidate model may be selected based on some combination of the AIC and error rate metric, such as a best performing model with respect to AIC that has a relatively low overall error rate, such as zero errors.

At 510, the method 500 can include storing in a multivariate model table, respective to each endogenous variable: parameters of the respective fitted residual forecasting model; a respective forecasted residual series of the plurality of forecasted residual series; and the one or more exogenous feature values. For instance, the parameters of each fitted residual forecasting model can be stored in a parameter store. Similarly, the forecasted residual series can collectively be stored as forecasted residual data store. The exogenous feature values can likewise be stored in an exogenous feature store. Each of the stores can correspond to respective portions (e.g., a first portion, a second portion, a third portion, etc.) of the model table. The respective portions may be contiguous or non-contiguous. The multivariate model table can be stored in any suitable memory device such as, for example, a memory of the system.

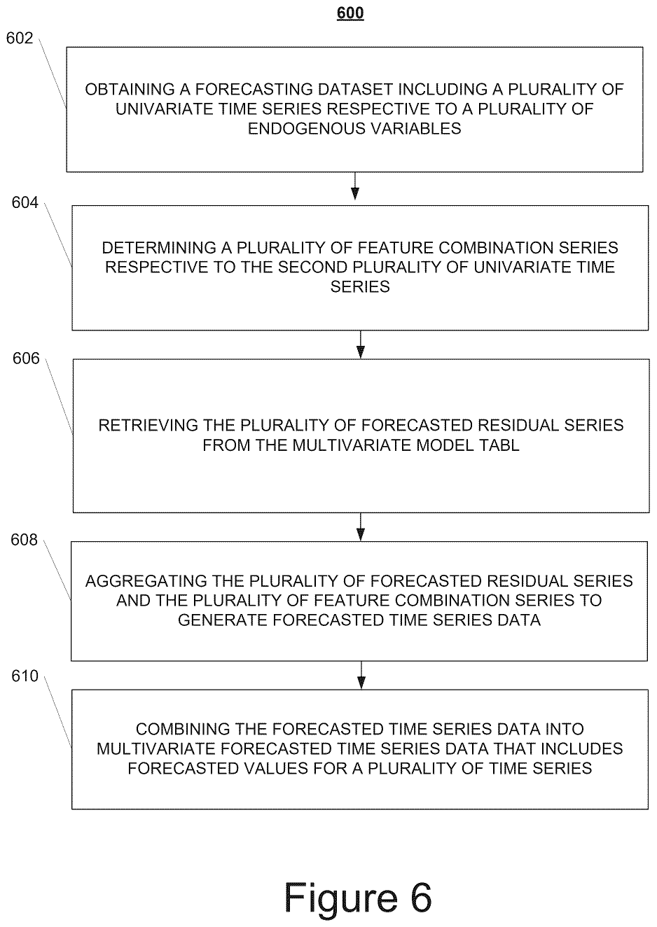

In some implementations, the method 500 can optionally include generating, using the multivariate model table, forecasted time series data for each of the endogenous variables. One example method for generating forecasted time series data for each of the endogenous variables is described below with respect to FIG. 6.

FIG. 6 depicts a flow chart diagram of an example method to perform parallelized multivariate time series forecasting according to example embodiments of the present disclosure. Although FIG. 6 depicts steps performed in a particular order for purposes of illustration and discussion, the methods of the present disclosure are not limited to the particularly illustrated order or arrangement. The various steps of the method 600 can be omitted, rearranged, combined, and/or adapted in various ways without deviating from the scope of the present disclosure.

The method 600 can include, at 602, obtaining a forecasting dataset including a second plurality of univariate time series respective to the plurality of endogenous variables. The method 600 can include, at 604, determining a plurality of feature combination series respective to the second plurality of univariate time series. For instance, generation of the feature combination series can be parallelized among a plurality of worker systems. The method 600 can include, at 606, retrieving the plurality of forecasted residual series from the multivariate model table. The method 600 can include, at 608, aggregating the plurality of forecasted residual series and the plurality of feature combination series to generate forecasted time series data. The method 600 can optionally include, at 610, combining the forecasted time series data into multivariate forecasted time series data that includes forecasted values for a plurality of time series.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computing system for parallelized multivariate time series forecasting, comprising:
one or more processors;
one or more non-transitory storage media coupled to the one or more processors, the one or more non-transitory storage media storing instructions that, when executed by the one or more processors, cause the one or more processors to perform operations, the operations including:
obtaining an input dataset comprising a plurality of univariate time series respective to a plurality of endogenous variables;
identifying a plurality of fitted regression models respective to the plurality of univariate time series by parallelized independent regression on each univariate time series of the plurality of univariate time series;
determining a plurality of residual series respective to the plurality of univariate time series and extracting one or more exogenous feature values from the plurality of univariate time series based on the plurality of fitted regression models;
forecasting a plurality of forecasted residual series respective to each of the plurality of residual series by a respective fitted residual forecasting model of a plurality of fitted forecasting model;
storing in a multivariate model table, respective to each endogenous variable:
parameters of the respective fitted residual forecasting model;
a respective forecasted residual series of the plurality of forecasted residual series; and
the one or more exogenous feature values; and
generating, using the multivariate model table, forecasted time series data for each of the endogenous variables.

2. The computing system of claim 1, wherein identifying the plurality of fitted regression models respective to the plurality of univariate time series comprises extracting a plurality of subtables respective to the plurality of endogenous variables.

3. The computing system of claim 2, wherein extracting the plurality of subtables comprises:
identifying a first value in a time series identifier column in the input dataset;
associating a plurality of rows of the input dataset with a first subtable of the plurality of subtables based on the plurality of rows having the first value in the time series identifier column;
identifying a second value in the time series identifier column in the input dataset; and
associating a second plurality of rows of the input dataset with a second subtable of the plurality of subtables based on the second plurality of rows having the second value in the time series.

4. The computing system of claim 1, wherein the one or more exogenous feature values comprise an exogenous feature weight and an exogenous feature intercept.

5. The computing system of claim 1, wherein the multivariate model table comprises, for each endogenous variable of the plurality of endogenous variables:
a first portion storing the parameters of the respective fitted residual forecasting model;
a second portion storing the respective forecasted residual series; and
a third portion storing the one or more exogenous feature values;
wherein the first portion, the second portion, and the third portion respectively comprise a plurality of nonoverlapping rows and a plurality of nonoverlapping columns.

6. The computing system of claim 5, wherein the plurality of nonoverlapping rows and the plurality of nonoverlapping columns comprise null values in overlapping positions.

7. The computing system of claim 1, wherein the plurality of fitted regression models comprise linear regression models and wherein the parallelized independent regression comprises linear regression.

8. The computing system of claim 1, wherein the plurality of fitted forecasting models comprise autoregressive integrated moving average (ARIMA) models.

9. The computing system of claim 1, wherein forecasting the plurality of forecasted residual series respective to each of the plurality of residual series by the respective fitted residual forecasting model of the plurality of fitted forecasting models comprises:
generating, for each residual series of the plurality of residual series, a plurality of candidate forecasting models;
evaluating a performance criterion for each of the plurality of candidate forecasting models; and
selecting one of the plurality of candidate forecasting models as the respective fitted residual forecasting model for the residual series based on the performance criterion.

10. The computing system of claim 9, wherein the performance criterion comprises an Akaike information criterion (AIC).

11. The computing system of claim 9, wherein the performance criterion comprises an error rate.

12. The computing system of claim 1, wherein the parallelized independent regression comprises fitting a regularization parameter to the plurality of univariate time series.

13. The computing system of claim 12, wherein the parallelized independent regression comprises, for each univariate time series of the plurality of univariate time series:
decomposing data points of the univariate time series into a plurality of coefficients;
generating a coefficient matrix based on the plurality of coefficients;
determining parameters of the fitted regression model respective to the univariate time series based on a factor comprising a sum of the regularization parameter with the product of a transposed coefficient matrix multiplied by the coefficient matrix.

14. The computing system of claim 1, wherein the parallelized independent regression is parallelized among a plurality of worker systems according to a parallelization schedule.

15. The computing system of claim 1, wherein generating, using the multivariate model table, the forecasted time series data for each of the endogenous variables comprises:
obtaining a forecasting dataset comprising a second plurality of univariate time series respective to the plurality of endogenous variables;
determining a plurality of feature combination series respective to the second plurality of univariate time series;
retrieving the plurality of forecasted residual series from the multivariate model table; and
aggregating the plurality of forecasted residual series and the plurality of feature combination series to generate the forecasted time series data.

16. A computer-implemented method, comprising:
obtaining, by a computing system comprising one or more computing devices, an input dataset comprising a plurality of univariate time series respective to a plurality of endogenous variables;
identifying, by the computing system, a plurality of fitted regression models respective to the plurality of univariate time series by parallelized independent regression on each univariate time series of the plurality of univariate time series;
determining, by the computing system, a plurality of residual series respective to the plurality of univariate time series and extracting one or more exogenous feature values from the plurality of univariate time series based on the plurality of fitted regression models;
forecasting, by the computing system, a plurality of forecasted residual series respective to each of the plurality of residual series by a respective fitted residual forecasting model of a plurality of fitted forecasting model;
storing in a multivariate model table, respective to each endogenous variable:
parameters of the respective fitted residual forecasting model;
a respective forecasted residual series of the plurality of forecasted residual series; and
the one or more exogenous feature values; and
generating, by the computing system and using the multivariate model table, forecasted time series data for each of the endogenous variables.

17. The computer-implemented method of claim 16, wherein identifying the plurality of fitted regression models respective to the plurality of univariate time series comprises extracting a plurality of subtables respective to the plurality of endogenous variables, wherein extracting the plurality of subtables comprises:
identifying a first value in a time series identifier column in the input dataset;
associating a plurality of rows of the input dataset with a first subtable of the plurality of subtables based on the plurality of rows having the first value in the time series identifier column;
identifying a second value in the time series identifier column in the input dataset; and
associating a second plurality of rows of the input dataset with a second subtable of the plurality of subtables based on the second plurality of rows having the second value in the time series.

18. The computer-implemented method of claim 16, wherein the multivariate model table comprises, for each endogenous variable of the plurality of endogenous variables:
a first portion storing the parameters of the respective fitted residual forecasting model;
a second portion storing the respective forecasted residual series; and
a third portion storing the one or more exogenous feature values;
wherein the first portion, the second portion, and the third portion respectively comprise a plurality of nonoverlapping rows and a plurality of nonoverlapping columns.

19. The computer-implemented method of claim 16, wherein the parallelized independent regression comprises fitting a regularization parameter to the plurality of univariate time series; and
for each univariate time series of the plurality of univariate time series:
decomposing data points of the univariate time series into a plurality of coefficients;
generating a coefficient matrix based on the plurality of coefficients;
determining parameters of the fitted regression model respective to the univariate time series based on a factor comprising a sum of the regularization parameter with the product of a transposed coefficient matrix multiplied by the coefficient matrix.

20. One or more non-transitory storage media storing instructions that, when executed by one or more processors, cause the one or more processors to perform operations, the operations including:
obtaining an input dataset comprising a plurality of univariate time series respective to a plurality of endogenous variables;
identifying a plurality of fitted regression models respective to the plurality of univariate time series by parallelized independent regression on each univariate time series of the plurality of univariate time series;
determining a plurality of residual series respective to the plurality of univariate time series and extracting one or more exogenous feature values from the plurality of univariate time series based on the plurality of fitted regression models;
forecasting a plurality of forecasted residual series respective to each of the plurality of residual series by a respective fitted residual forecasting model of a plurality of fitted forecasting model;
storing in a multivariate model table, respective to each endogenous variable:
parameters of the respective fitted residual forecasting model;
a respective forecasted residual series of the plurality of forecasted residual series; and
the one or more exogenous feature values; and
generating, using the multivariate model table, forecasted time series data for each of the endogenous variables.
